(19) United States
(12) Patent Application Publication
(10) Pub. No.: US 2026/0051306 A1
(43) Pub. Date: Feb. 19, 2026

(54) Music Synthesizer Using Resonators

(71) Applicant: Eventide Inc., Little Ferry, NJ (US)

(72) Inventor: Anthony M. Agnello, Princeton, NJ (US)

(73) Assignee: Eventide Inc., Little Ferry, NJ (US)

(21) Appl. No.: 18/801,960

(22) Filed: Aug. 13, 2024

(51) Int. Cl. G10H 1/00; G10H 1/02

(52) U.S. Cl. CPC G10H 1/0091; G10H 1/0066; G10H 1/02

(57) ABSTRACT

A musical synthesizer produces an audio signal using a set including hundreds or thousands of resonators. The resonators can be based on analysis of any acoustic space such as an acoustic instrument, room, studio, or concert hall A machine learning network is trained to learn the characteristics of a musical sound. The characteristic may be whether the sound is pleasing to the human ear. The network produces audio effects applied to selected frequencies in the spectrum. An input or excitation signal is provided to the network, which processes the input through a trained model of a target audio source and configures the set of resonators to produce an output audio signal based on the input signal. The network may be expanded to create novel impulse responses creating tones and timbre unique to existing audio sources, the input signal may include musical tones or include vocal inputs.

### BACKGROUND

Audio signal processing involves the electronic manipulation of audio signals. Audio signals are electronic representations of sound waves which travel through air. Audio signals may be represented in analog or digital form. Processing or manipulation of the signals may be performed in either the analog or digital domain. Due do the electronic nature of the representative signals, computer-based devices may be used to synthesize audio signals by generating the electronic signals that may be interpreted as sound waves. An analog signal is a continuous and varying electrical voltage that is analogous to a sound wave travelling through air. Digital signals on the other hand, represent a waveform as a sequence of discrete values or symbols (e.g., a binary number). The more values per unit time in the digital signal, the closer the output resembles an analog signal to produce an output sound wave. The ability to manipulate audio signals allows for the enhancement of source input signals and opens the door for synthesizing other sounds by creating audio signals from other data.

### SUMMARY

An array of resonator circuits may be provided with an excitation signal applied to each resonator circuit in the array. The resonator circuits can be tuned to emit different frequencies based on the input signal. The excitation signal may be a noise signal such as pink noise. The excited resonator circuits produce a raw output signal with different frequency amplitudes across the frequency domain. A user may provide an input, such as a signal representative of a particular musical note or combination of notes which is applied to the resonator array. The user’s input is reflected in the output signal of the resonator array as higher frequency amplitude for frequencies corresponding to the user input.

Acoustic effects, such as amplitude, decay, and phase advance may be applied to an output of the resonator array. The acoustic effects may be applied to selected frequencies in the frequency band. The acoustic effects may be applied to frequencies selected for their relation to the user input. For example, the frequencies near the user input, or frequencies corresponding to octave intervals of the user input as well as other intervals from the user input. The acoustic effects may have the effect of producing a sound wave from the modified output of the resonator array. The effects may be used to create new sounds and timbres that are not previously known. In this manner, new and interesting sounds may be created that have never been heard before. Other applications can apply acoustic effects to capture the acoustic signature of a particular space, such as a concert hall or recording studio. In other applications, acoustic effects may be applied to reproduce the sound and timbre of a particular instrument.

According to some aspects of this disclosure, artificial intelligence may be applied to create the acoustic effects, and which frequencies in the frequency spectrum will have acoustic effects applied to them.

### BRIEF DESCRIPTION OF THE DRAWINGS

FIG. 1 is an illustration of a resonator-based audio synthesizer according to aspects of this disclosure.

FIG. 2 is a training process in a neural network for producing an audio signal from a set of resonators according to aspects of the disclosure.

FIG. 3 is an illustration of a system for producing an impulse response from a set of resonators according to aspects of the disclosure.

FIG. 4 illustrates the recreation of an acoustic source in a set of resonators according to aspects of the disclosure.

FIG. 5 shows the operation of a musical synthesizer according to aspects of the disclosure.

FIG. 6 is a computing device for implementing the production of an impulse response according to aspects of the disclosure.

FIG. 7 is a process flow diagram for training a neural network for producing an impulse response from a set of resonators according to aspects of the disclosure.

FIG. 8 is a process flow diagram for operating a music synthesizer according to aspects of the disclosure.

### DETAILED DESCRIPTION

The reverberance of an acoustic space can be defined by its impulse response or by a set of resonances called modes. The resonances define a room, chamber, instrument body or any acoustic body. If these resonances can be reproduced, then an instrument, concert hall, recording studio and the like can be simulated without having access to the original source space.

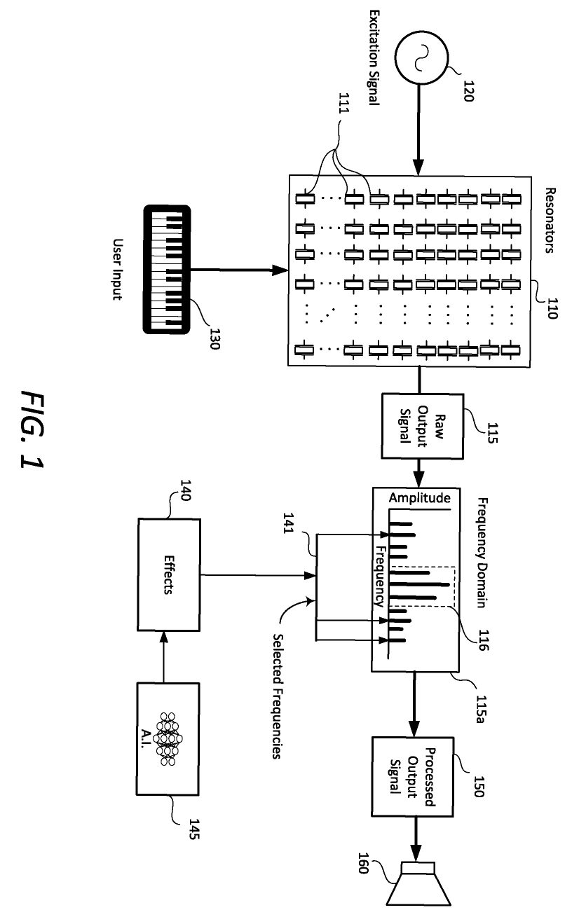

FIG. 1 is an illustration of an audio synthesizer according to aspects of this disclosure. An array of resonators 110 includes a number of resonator circuits 111 that can receive an electrical input signal and convert that electrical input signal into a wave signal having a particular frequency. Each resonator circuit 111 has properties that cause it to oscillate at greater amplitude at and around its resonant frequency than at other frequencies. Resonator circuits 111 may include an inductor and a capacitor whose inductance and capacitance levels cause current through the resonator circuit 111 to oscillate at a specific resonant frequency. A resonator circuit 111 may further include a resistance element, which can affect the peak resonant frequency of the resonator circuit 111. Each resonator circuit 111 may be tuned to a specific resonant frequency. Acoustic resonators use their resonant frequencies to produce sound waves of specific tones. Resonators can be created in the digital domain implemented as a digital filter. A resonator array 110 can contain thousands or tens of thousands of resonator circuits 111 each tuned to a specific resonant frequency. When a voltage is applied to a resonator circuit 111 the components of the circuit conduct current and interact with each other to produce a frequency.

The resonator array 110 may receive an excitation signal 120 that is applied to each resonator circuit 111 in the resonator array 111. In response to the excitation signal 120 each resonator circuit 111 will oscillate and produce its frequency that serves as one component of the raw output signal 115 of the resonator array 110. The excitation signal 120 may be selected to produce a particular baseline for the raw output signal 115 of the resonator array 110. In one non-limiting example, pink noise may be used as an excitation signal. 110. Pink noise is a signal that has a frequency spectrum the power of each frequency interval is inversely proportional to the frequency of the signal. Pink noise is commonly observed in nature and is commonly used to tune audio systems. Due to the nature of pink noise to occur in nature, audio systems can be used to process, filter, and/or add effects to produce desired sounds.

In addition to the excitation signal 120, the resonator array 110 can receive additional user inputs 130. The user may use a musical keyboard, MIDI controller, computer interface or other means to transmit a musical input to the resonator array 110. The user input 130 may represent a specific musical note, or group of notes, such as a chord. For example, a user may press the middle A key on a keyboard, which causes the outputs at and near 440 Hz to be amplified. The represented note or notes will be applied to selected resonator circuits 111 corresponding to the note or notes and produce increased energy levels at the notes’ corresponding frequencies. The increased energy at the frequencies corresponding to the user input 130 will be represented in the raw output signal 115 of the resonator array 110.

The raw output signal 115 can be represented in the frequency domain 115a as individual signals at each frequency. Each frequency may have a level of energy. Frequencies that represent the user input 130 may have an increased amplitude 116 with respect to other frequencies that may have energy that was produced from the excitation signal 120.

The raw output signal 115 may be further processed to produce a processed output signal 150. One or more acoustic effects 140 may be applied to the raw output signal 115 to enhance or alter the processed output signal 150. Further, selected frequencies 141 may be identified, and acoustic effects 140 applied only to the selected frequencies 141. The selected frequencies may include frequencies that occur near the user input 116 on the frequency spectrum or may be selected to produce acoustic effects 140 at other frequencies in the spectrum, such as octaves, harmonics, selected intervals, or other modes corresponding to the user input 116.

Acoustic effects 140 that may be applied to selected frequencies 141 may include decay, phase advance/retard, and/or altering amplitude. The acoustic effects 140 may be applied in combination with one another and applied strategically to selected frequencies 141 to produce sound effects that work together with the user input 130 to produce a desired sound. The desired sound may be an effect that recreates a physical acoustic space, such as a concert hall or recording studio. In some cases, the selection of effects may reproduce the sound of a particular musical instrument. Further, novel sounds that have not been previously perceived may be created to produce new and interesting instrumental sounds.

The resonator array 110 may contain many thousands of resonator circuits 111 that cover a broad range of the frequency spectrum over many frequencies. The combinations of frequencies and one or more acoustic effects 140 that may be applied to any number of those frequencies or combinations of frequencies represent a massive number of options available to produce new and exciting sounds. To aid in the discovery of new sounds and instrumentations, artificial intelligence (AI) 145 may be applied to apply acoustic effects 140 to selected frequencies 141 in the raw output signal 115. AI 145 can be trained to recognize sounds and effects that are pleasing to the ear. Further, AI can analyze signals to determine the characteristics of a signal that result in a pleasing result. Using that knowledge, the AI 145 may select acoustic effects 140 and instruct the synthesizer system to apply certain acoustic effects 140 to a specific number of selected frequencies 141. The result is a processed output signal 150 that will produce a pleasing sound when processed through an audio speaker 160 or other sound producing device.

AI 145 may take the form of a neural network. Neural networks are machine learning (ML) models that include one or more layers of nonlinear operations to predict an output for a received input. In addition to an input layer and an output layer, some neural networks include one or more hidden layers. The output of each hidden layer can be input to another hidden layer or the output layer of the neural network. Each layer of the neural network can generate a respective output from a received input according to values for one or more model parameters for the layer. The model parameters can be weights or biases that are determined through a training algorithm to cause the neural network to generate accurate output. In aspects of this disclosure, the input to the ML model may be an audio input, including streamed audio, pre-recorded audio, or audio as part of a video or other source or media. A machine learning model within an audio context may include isolating components of the input signal, such as different voices, instruments, reverberation, harmonics and other characteristics of the input. The model may isolate different aspects of the audio input and enhance certain characteristics of components to make them more or less perceivable to the ear or may use the information in the input signal to create new and previously unknown audio sources. During training, the model is provided audio samples which may be associated with other inputs, such as the pleasantness of the audio based on the metadata obtained from human perception of the audio signal and the human’s impression of the input as pleasant or desirable. The accurate output of the model will correspond to what the training of the model has indicated as desirable.

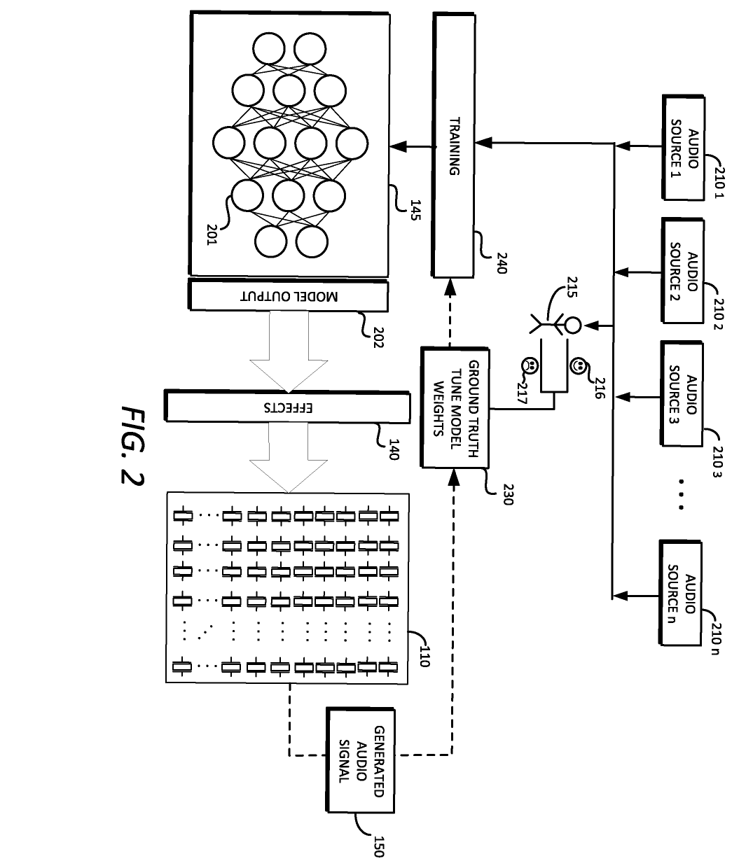

FIG. 2 is a system for training artificial intelligence 145 to create an audio signal using a set of resonators according to aspects of this disclosure. Audio sources 210 are examples of sounds, tones, notes or timbres among other characteristic that define sounds, The various audio samples 210 are provided as training data 240 for the AI neural network 145. The audio samples 210 are also provided to a human 215 (or group of humans) to determine the content of the audio input source 210 is pleasing 216 to the person 215, or if the person 215 deems the audio source 210 to be unpleasant 217. This human feedback is stored as ground truth 230 which represents the real-world desirability of a given input audio source 210 as perceived by actual humans 215.

An AI network 145 can generate an output that is applied to the resonators 110. The set of resonators 110 may all be the same and controlled by the parameters and inputs provided to the resonator circuit. The AI network can determine the settings and parameters to apply to some of the resonators 110 to produce the desired frequencies. In some cases, an impulse response may be used to establish characteristics such as relative levels, decay and phase of the set of resonators 110. A user or the AI network 145 can modify parameters in the set of resonators 110 to generate notes or other sounds based on the impulse response. The AI network 145 can be a neural network 201 or similar machine learning mechanism. The neural network 201 produces a model output 202 containing a set of resonator parameters that include the audio effects 140 that when provided to the resonator array 110 control the resonators in the array of resonators 110. When audio effects 140 are applied to the resonators 110, the resonators 110 produce a generated audio signal 150. By way of example, consider audio source 3 210₃. The ground truth representing the desirability 216 or undesirability 217 of the audio source 3 210₃ is compared to the generated audio signal 150 to determine the difference between ground truth 230 and the model output (generated audio signal 150). Based on the comparison, the generated audio signal 150 is characterized as being a pleasant sounding signal, or an unpleasant sounding signal. This information is provided as additional training data 240 and used to further adjust the weights and biases of AI network 145. The trained AI network 145 learns what is pleasing or unpleasing to a human listener and a can direct data through the AI network 145 to produce a model output 202 defining audio effects 140 to apply against selected frequencies in the frequency spectrum as discussed above with respect to FIG. 1.

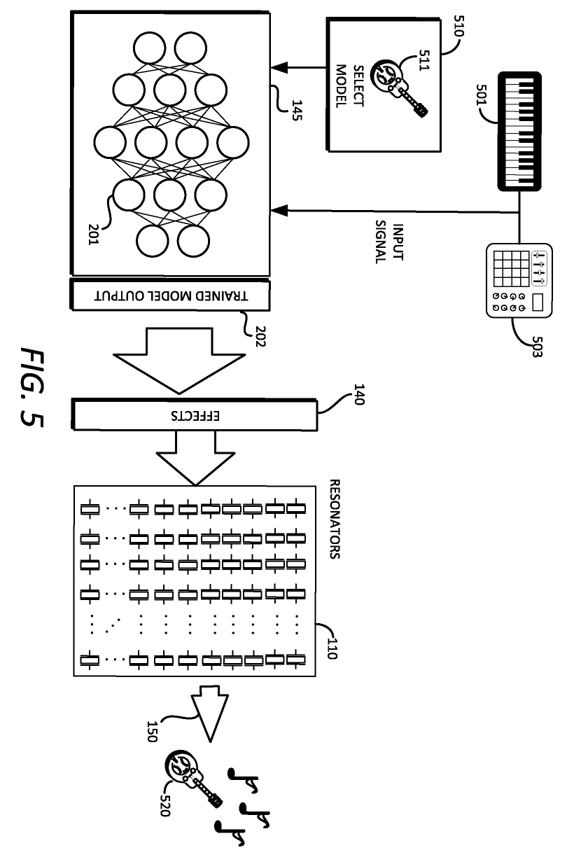

Models may be trained for any number of input sources or purposes. The trained models 202 may comprise a library of trained models where a user may select a desired audio source 210 and produce an input (503 in FIG. 5) that will be converted to an audio signal 150 that has similar qualities to the modeled input source. In some cases, the output may be representative of a particular instrument. Additionally, the output may be representative of a particular location or landmark (audio space) where the original input source 210 was produced. The array of resonators 110 produce frequencies that span the entire audio spectrum. Particular resonators 110 can be centered at frequencies that correspond to the notes of any musical scale. The model may specify a subset of resonators 130 corresponding to a particular note based on an input provided to the model. When considering modal representations of acoustic spaces, the choice of resonators is derived from the impulse response of the space so that the instrument should impart the character of the room. In some embodiments this is not necessary the set of resonators could be generic. In these embodiments the resonators may be perceived as thousands of small and large pipes, bells, strings or any other source that vibrates at an audio frequency when excited that reproduce an audio signal matching the original source 210.

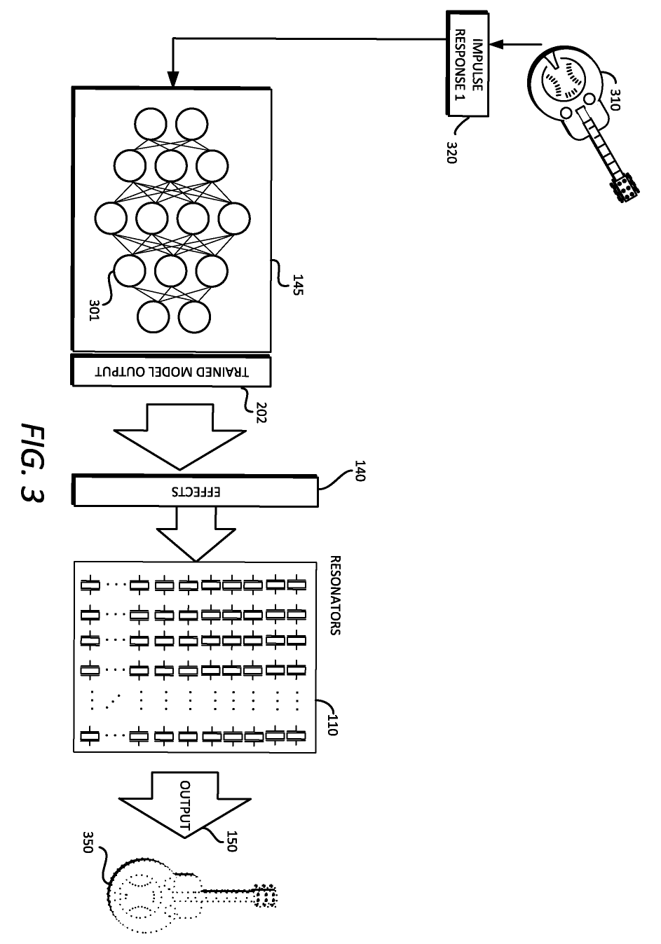

Referring now to FIG. 3 an example of a use of a resonator-based synthesizer is shown. A selected input, such as guitar 310 is associated with a given impulse response 320. An input (305 of FIG. 5) is presented to trained model 301 which produces model output 202. Output 302 may comprise a set of audio effects 140 containing parameters for controlling the operation of one or more resonators 110. The resonators 110 produce an audio signal output 150 resulting from the application of audio effects 140. The audio signal output 150 replicates 350 the audio signal output 150 to sound like it was produced by guitar 310. Software could further be configured to control the resonators in such a way that they ‘speak’ or ‘sing.’ Some models could be trained to make speech sounds. In this case, using the resonators that represent a specific acoustic space can impart a character to the synthesized voice.

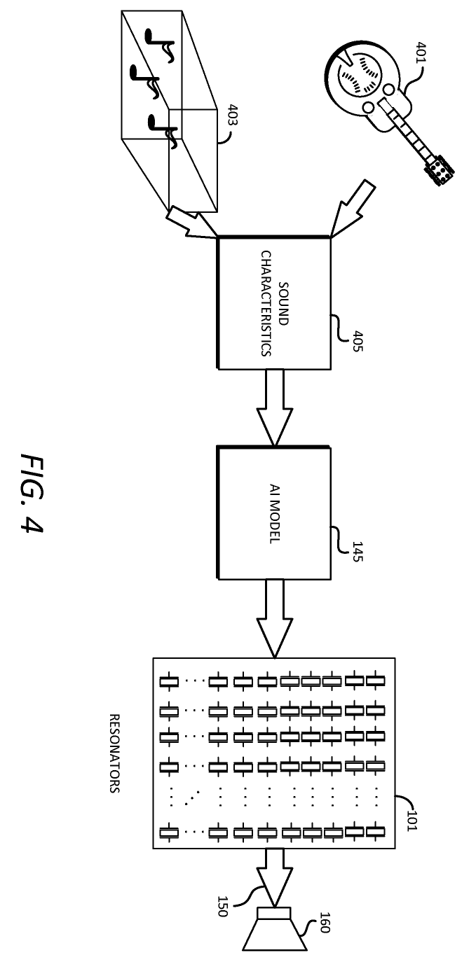

FIG. 4 is an example of a user for an AI enhanced resonator-based music synthesizer according to aspects of this disclosure. Raw audio sources, such as an instrument 401 or a particular acoustic space 403 create unique sound characteristics 405 that characterize the quality, tone or timber of the instrument 401 or space 403. The sound characteristics 405 may be formatted to a form that is ingestible by an AI network 145. The model contained in the AI network 145 may have been trained for example, by the training process described in FIG. 2. The AI network 145 will have knowledge of human preferences for the pleasantness of a given sound and may apply this knowledge to the provided sound characteristics 405 to produce enhanced or additional pleasing features by producing audio effects and applying the audio effects to selected resonators in the resonator array 110. The resonator array will produce an audio output signal 150 that can be provided to a speaker 160 of other audio device to create a perceptible sound from the audio signal 150.

Using the example of FIG. 4, output audio signals 150 may be produced, which emulate the unique qualities of the input source 401, 403. For example, an audio space 403 may be well known and highly regarded space that has created successful music in the past, such as a recording studio like Muscle Shoals, Motown’s Hitsville USA or Abbey Road. Although the success of the music produced in these spaces relies much on the talent and creativity of the performers, the spaces themselves have acoustic signatures that are unique to that space and contribute to the overall feel of the music. The dimensions and structural acoustic of the space create reverberations and modes of vibration that create the spirit and tone of the music created there. An sound characteristics 405 may contain a representation of those unique qualities and be used to create an audio output signal 150 that sounds like it was created in a famous space, although in actuality it was created in a remote location.

FIG. 5 illustrates an example of using a resonator-based music synthesizer according to aspects of this disclosure. An input signal may be provided to the AI network 145 by any means, including but not limited to a keyboard 501, or a computing device such as a MIDI controller 503. The input signal represents an audio signal such as one or more musical notes. The input signal is processed according to the trained AI model 510 to produce the trained model output 202 including a set of resonator parameters that produce audio effects 140. The audio effects are applied to selected resonators in the array of resonators 110 and produce an audio signal 150 based on the input signal, the output having the qualities of the original source that the selected model 510 is based on.

A resonator-based synthesizer may provide a user interface that presents to a user a library of sound models 510 that may model a musical instrument 511 or may emulate sounds coming from a particular acoustic space. Further, models 510 may be trained to recognize the characteristics of a piece of music that is pleasant to the human ear. The synthesizer may include an input device, or an input port for receiving an input device, such as a keyboard 501 or MIDI controller 503. The AI network 145 receives the user selected model 510 along with the input from the input device. The AI network receives the user input 501, 503 and processes the input according to the selected model 510. The model output 202 includes the information needed to create audio effects 140 to apply to selected resonators in the resonator array 110. The model output 202 may include a selection of designated frequencies corresponding to the user input 501, 503. The frequencies may include the frequencies of the notes input by the user and may further include additional frequencies around the user input. The additional frequencies may be notes complementary to the user input. Other effects such as phase advance, decay and amplitude may be applied in any combination to some or all of the selected frequencies. The effects are applied as parameters to selected resonators within the resonator array 110 to produce an audio signal output 150.

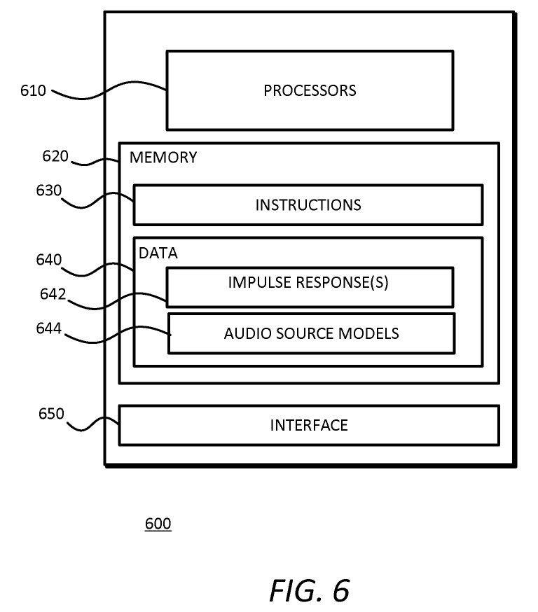

FIG. 6 illustrates an example system 600 for performing the recreation of a source impulse response using resonators as described in this disclosure. The system 600 may include one or more processing devices 610 configured to execute a set of instructions or executable programs. The processors 610 may be dedicated components such as general-purpose CPUs, or application specific integrated circuits (ASICs), or may be other hardware-based processors. Although not necessary, specialized hardware components may be included to perform specific computing processes faster or more efficiently. For example, operations of the present dis closure may be carried out in parallel on a computer architecture having multiple cores with parallel processing capabilities.

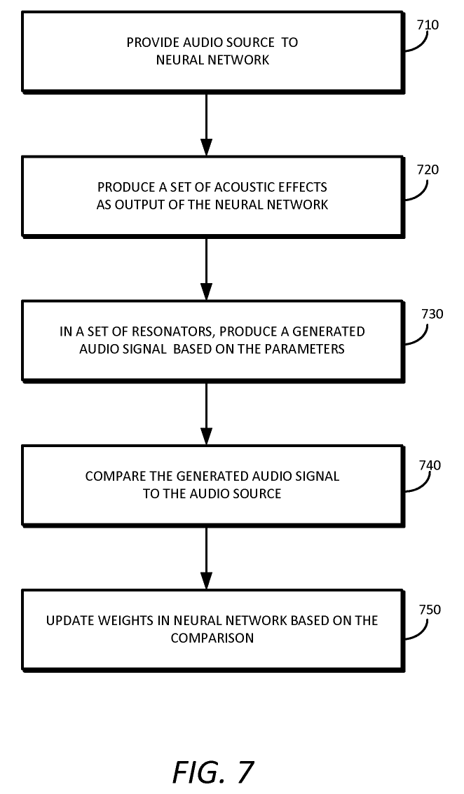

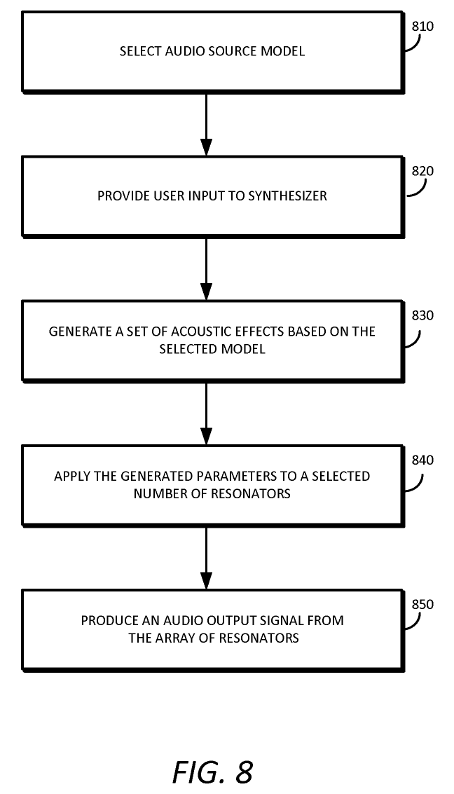

Various instructions are described in greater detail in connection with the flow diagrams in FIGS. 7 and 8. The system may further include one or more storage devices or memory 620 for storing the instructions 630 and programs executed by the one or more processors 610. Additionally, the memory 620 may be configured to store data 640, such as one or more trained models 644 of an original audio source and the impulse responses 642.

The system 600 may further include an interface 650 for input and output of data. For example, a model may be selected for input to the system 600 via the interface 650, and an audio signal output based on a selected model and a user input may be produced as output via the interface 650.

In some examples, the system 600 may include a personal computer, laptop, tablet, or other computing device of the user, housing therein both processors 610 and memory 620. Operations performed by the system 600 are described in greater detail in the accompanying figures and descriptions.

Other parameters and instructions may be provided to and from the system 600 via the interface 650. For example, parameters for controlling a collection of resonators may be identified by an input provided by the user.

FIG. 7 is a flow diagram for a method of training a model of an audio source according to aspects of this disclosure. An audio source is provided to a neural network 710. The audio source may be an impulse response corresponding to a particular musical instrument or an impulse response corresponding to a particular acoustic space. The audio source may be an audio sample labeled as to whether the audio sample is pleasing to the human ear. The audio sample may be listened to by a human and the human indicates whether the audio sample is pleasing to the human. The human provides an indication that is saved and associated with the audio sample as a label. The input audio source is processed by a neural network to produce an output that includes a set of acoustic effects 720. The acoustic effects may take the form as a set of parameters for a selected number of resonator circuits in an array of resonator circuits. The resonator circuit parameters are applied to the selected resonator circuits to produce a generated audio signal based on the parameters 730. The generated impulse response is compared to the source impulse response to determine differences between the audio source and the generated audio signal 740. Based on the comparison, weights are adjusted in the neural network to approximate the audio source more closely 750.

FIG. 8 is a process flow diagram for producing an audio signal in a resonator-based synthesizer according to aspects of this disclosure. A user selects a model representing an audio source they want to emulate 810. A user input is provided to the model 820. The user input may be provided by any suitable input device including but not limited to a musical keyboard or a computer device like a MIDI controller. The model processes the input and generates a set of acoustic effects in the form of resonator parameters based on the selected model and the input signal 830. The acoustic effects can be specified for application to a selected number of resonator circuits in an array of resonator circuits 840. In response to an excitation signal, the affected resonators in the resonator array produce frequencies that form an audio signal based on the input signal and the selected model 850.

Systems of this disclosure allow the user to control and manipulate the set of resonators including the amplitude/level of each resonator. Typically, this is controlled by the keyboard’s dynamics. Additionally, a user may control the decay time of each resonator. This can be controlled in various ways for example by the keyboard’s foot pedal.

To reproduce notes, a range of resonators centered at the note can be sounded. For example, if the A key on the keyboard which corresponds to 440 Hz is depressed, a single resonator at 440 Hz can sound or a range of resonators centered at 440 Hz can sound. The level of the various resonators within this range can be constant or their levels can be modulated by various means. The user may select a single note corresponding to the key pressed or several notes octaves apart. In other words, if the note A on the keyboard is pressed, the instrument can output the resonator at the frequency corresponding to the A on the keyboard or all (or any combo) of As (55 Hz, 110, 220, 440, 880, 1760, 3520, 7040, 14080). Resonators at frequencies that are not related to the note A can also contribute to the synthesized note, adding timbral elements through control of the shape or envelope of the additional resonators.

In some aspects, the envelop, timing and level of the excitation signal may be controlled by the user The user may determine whether the excitation is constant or only applied upon pressing a key. With constant excitation the resonator will sound immediately, if instant resonance will build (swell) upon key press. Other characteristics of the output audio signal may be controlled, including but not limited to global decay time, size of enclosure and/or tone/EQ.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. An audio synthesizing device comprising:
a plurality of resonator circuits, wherein different resonator circuits are tuned to generate different output frequencies; an excitation signal that when applied to the array caused one or more resonator circuits in the plurality of resonator circuits to output a signal at an associated frequency; an acoustic effects module for applying one or more acoustic effects to selected frequencies from a frequency spectrum generated by the plurality of resonator circuits.

2. The audio synthesizing device of claim 1, wherein the one or more acoustic effects is selected from one or more of a phase advance, an amplitude level, and a decay interval.

3. The audio synthesizer device of claim 1, further comprising the one or more acoustic effects comprising a set of parameters, the set of parameters comprising an input to a resonator circuit of the plurality of resonator circuits.

4. The audio synthesizer device of claim 1, further comprising:
in input port for receiving a user input device.

5. The audio synthesizer device of claim 4, wherein the user input device is a musical keyboard.

6. The audio synthesizer device of claim 4, wherein the user input device is a musical instrument digital interface (MIDI) controller.

7. The audio synthesizer device of claim 4, wherein user input device receives an input from a user and the acoustic effects module applies the one or more acoustic effects to selected frequency corresponding to frequencies of the input from the user.

8. The audio synthesizer device of claim 1, further comprising:
an artificial intelligence (AI) network in communication with the acoustic effects module.

9. The audio synthesizer device of claim 8, wherein the AI network stores a library of models, a model providing inputs to the acoustic effects module for applying acoustic effects to frequencies selected by the AI network.

10. The audio synthesizer device of claim 8, wherein the AI network is trained with audio samples, the audio samples having labels indicating if the audio samples contain a pleasing sound.

11. The audio synthesizer device of claim 8, wherein the AI network is trained to contain models that emulate a particular musical instrument.

12. The audio synthesizer of claim 8, wherein the AI network is trained to contain models that emulate a particular acoustic space.

13. A method for producing and audio output from a plurality of resonator circuits comprising:
receiving at the plurality of resonator circuits, an excitation signal to produce a frequency from at least one of the plurality of resonators circuits; in an acoustic effects module, applying at least one acoustic effect to a selected number of the plurality of resonator circuits; producing, from the plurality of resonator circuits, an acoustic signal based on the excitation signal and the applied acoustic effects.

14. The method of claim 13, further comprising:
in a model of an artificial intelligence (AI) network, selecting one or more acoustic effects and the selected number of the plurality of resonator circuits; and
providing the selected one or more audio effects and the selected number of resonator circuits to an acoustic effects module.

15. The method of claim 14, further comprising:
applying, by the acoustic effects module, the selected one or more acoustic effects to the selected number of resonator circuits; and
producing an audio signal output based on the acoustic effects and selected frequencies.

16. The method of claim 15, wherein one or more acoustic effects are selected from one or more of a phase advance, an amplitude level, and a decay interval.

17. The method of claim 15, further comprising:
training the AI network with a plurality of audio samples, each audio sample labeled to indicate if the audio sample is pleasing to a human ear.

18. The method of claim 17, further comprising:
producing the audio signal output from a model of the AI network, the model trained to produce an audio sample that is pleasing to the human ear.

19. The method of claim 15, further comprising:
producing the audio signal output from a model of the AI network, the model trained to produce an audio sample that emulates a particular musical instrument.

20. The method of claim 15, further comprising:
producing the audio signal output from a model of the AI network, the model trained to produce an audio sample that emulates a particular audio space.
